(19) United States
(12) Patent Application Publication
(10) Pub. No.: US 2004/0246824 A1
(43) Pub. Date: Dec. 9, 2004

(54) Method for reading table of content of multi-session optical medium

(75) Inventors: Yuan-Ting Wu, Hsin-Chu City (TW); Tun-Hsing Liu, Yu Lin Hsien (TW)

Correspondence Address: BROWDY AND NEIMARK, P.L.L.C., 624 NINTH STREET, NW, SUITE 300, WASHINGTON, DC, 20001-5303, US

(73) Assignee: MEDIA TEK INC., Hsin-Chu City (TW)

(21) Appl. No.: 10/456,542

(22) Filed: Jun. 9, 2003

(51) Int. Cl. G11B 7/085

(52) U.S. Cl. 369/30.07; 369/47.13; 369/59.25

(57) ABSTRACT

A method for reading a table of content (TOC) of a multi-session optical medium is provided. This method includes providing a memory for storing the TOCs of sessions having stored said digital information therein, reading TOC stored in the memory out as the change of the digital information state is adding another session, and combining the stored TOCs with the TOC of the newly-added session together, and changing the digital information state of the latest-stored session at first, and then storing the changed digital information state of the latest-stored session into the memory as the change of the digital information state is not adding another session.

### BACKGROUND OF THE INVENTION

1. Field of the Invention

The present invention relates to a method for reading tables of contents of a multi-session optical medium, and more particularly, to a method of storing tables of contents of sessions having stored digital information thereon into the memory and reading these tables of contents out so as to be integrated with the table of content of newly-added session together, thereby obtaining the refreshed table of content of the optical medium after another new session is added.

2. Description of the Prior Art

Please refer to FIG. 1 of a schematic diagram illustrating the structure of a multi-session optical medium 20. The optical medium 20 includes a first session 21, a second session 22, and a third session 23, each of which includes a lead-in area 211, 221, and 231, a program area 212, 222, and 232, and a lead-out area 213, 223, and 233, respectively. Lead-in areas 211, 221, and 231 are for storing tables of contents of sessions 21, 22, and 23, respectively; program areas 212, 222, and 232 are for storing the digital information stored in sessions 21, 22, and 23, respectively. Typical digital information is data or audio/video information, and the table of content includes the information regarding the start time of this session, the number of tracks, and the size of the program area of this session.

After some digital information is recorded into a given session, the table of content of this session no doubt will be changed accordingly with respect to the digital information recording. One prior art method moves the optical pickup head of the optical player compatible with given optical media back to every lead-in area of every session, including the latest-stored one, so as to read these tables of contents out, as the digital information has been recorded into the latest-stored session, thereby providing the refreshed table of content of the optical medium to the optical player. In conjunction with FIG. 1, while the digital information has been recorded into the third session 23, the pickup head (not shown) has to be moved to the first lead-in area 211, the second lead-in area 221, and the third lead-in area 231, in this order, to read tables of contents thereof respectively. And, after the fourth session (not shown in FIG. 1 but located right after the third session) has completed its digital information recording, this prior method moves the pickup head to lead-in areas of these four sessions, all of which already have digital information stored, sequentially from the first session representing storing the digital information earliest to the latest-stored (fourth) session, for reading tables of contents stored in lead-in areas thereof, respectively. In other words, the optical pickup head has to move to every lead-in area for the purpose of reading the table of content of each session, including the latest-stored one, having digital information stored, as the digital information recording goes on. Apparently, it will be disadvantageous as the target session for the information recording is farther and farther away from the physical center of the optical medium and the total number of tracks increases accordingly while the digital information keeps being recorded into the optical medium, resulting in the time of reading these tables of contents and the overall period of providing the refreshed table of content of this optical medium to the optical medium player while performing next digital information recording accumulate simultaneously. Additionally, the optical medium player also needs to read the information stored in the program management area, which is located ahead of the aforementioned first session lead-in area, of the optical medium on some occasions, but the prior art method still moves the optical pickup head to the program management area after performing every task of digital information recording, so as to satisfy this requirement. Therefore, the optical pickup head has no option other than taking much more time on moving to every lead-in area of each session that has the digital information stored.

### SUMMARY OF THE INVENTION

It is therefore a primary objective of the present invention to provide a method for reading the table of content (hereinafter refer to as “TOC”) of the multi-session optical medium. Based on the method according to the present invention, the TOC of every session will be stored into the memory as the respective digital information recording to any given session is completed. Thus, in the wake of having another information recording performed, the optical pickup head will no longer move to every lead-in area of each session previously having the digital information stored in advance but read these TOCs previously stored in the memory out directly. Plus, the TOC of the current session will be recognized as the digital information of this session is recorded, therefore, combining TOC of the current session with TOCs representing other sessions ahead of current session and stored in the memory previously together provides a refreshed TOC of the optical medium.

In accordance with claimed invention, the present invention method includes steps as follows: providing a memory for storing the TOC of each session having stored the digital information therein; as the change of the digital information state is adding another session, reading the TOCs stored in the memory out, and combining the stored TOCs with TOC of the newly-added session together; and as the change of the digital information state is not adding another session, changing the digital information state of the latest-stored session at first, and then storing the changed digital information state of the latest-stored session into the memory.

It is an advantage of the present invention that the optical pickup head will no longer have to be moved to each lead-in area of each session that has the digital information stored while another digital information recording for another session is completed. In other words, the present method stores TOCs of sessions already have stored digital information therein to the memory as the corresponding digital information recording operation for each of them is once completed, thereby reading out TOCs directly from the memory, and combining these TOCs with the TOC of the session which has just the digital information recording thereof completed together, so as to provide the refreshed TOC of the optical medium to the optical player without additionally moving the optical pickup head.

These and other objectives of the present invention will no doubt become obvious to those of ordinary skill in the art after reading the following. detailed description of the preferred embodiment that is illustrated in the various figures and drawings.

### BRIEF DESCRIPTION OF THE DRAWINGS

FIG. 1 is schematic diagram illustrating the structure of a multi-session optical medium.

FIG. 2 is a flow chart illustrating a method for reading the TOC of the optical medium based on the present invention.

### DETAILED DESCRIPTION OF THE PREFERRED EMBODIMENT

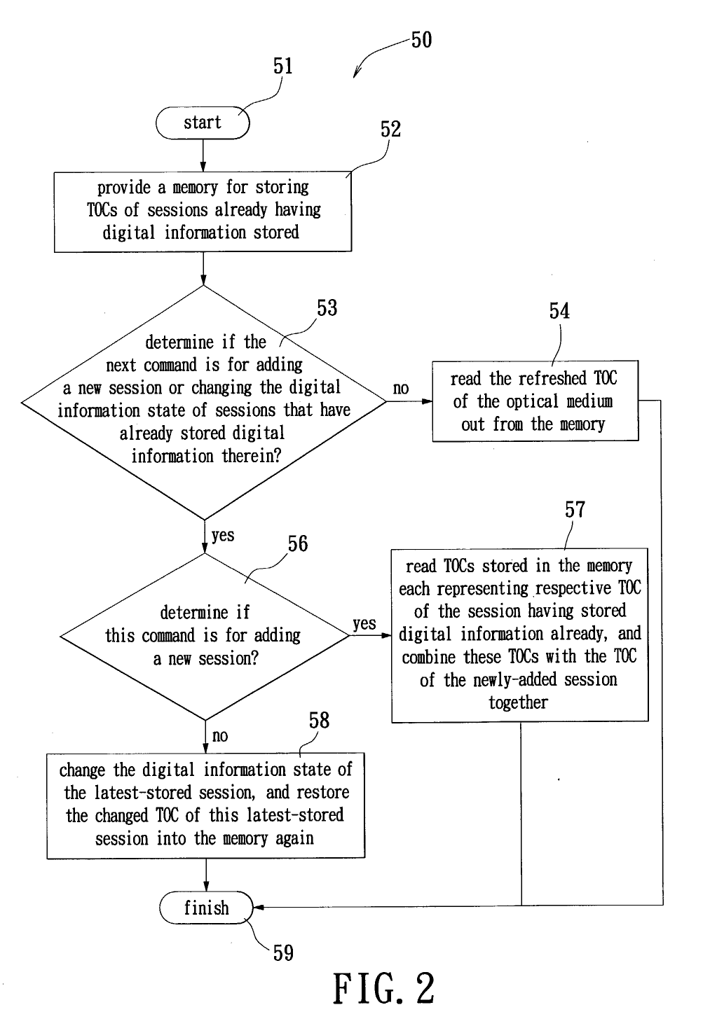

Please refer to FIG. 2 of a flow chart illustrating the method for reading the TOC of the optical medium 50 according to the present invention. The present method 50 includes following steps:

Step 51: start;

Step 52: provide a memory for storing TOCs of sessions already having digital information stored;

Step 53: determine if the next command is for adding a new session or changing the digital information state of sessions that have already stored digital information therein; if yes, go to Step 56, or go to Step 54 instead;

Step 54: read the refreshed TOC of the optical medium out from the memory;

Step 56: determine if this command is for adding a new session; if yes, go to Step 57, otherwise, go to Step 58;

Step 57: read TOCs stored in the memory each representing respective TOC of the session having stored digital information already, and combine these TOCs with the TOC of the newly-added session together;

Step 58: change the digital information state of the latest-stored session, and at last restore the changed TOC of this latest-stored session into the memory again; and

Step 59: finish.

The present invention provides a memory, preferably, a DRAM, for storing TOCs of these sessions that have already stored respective digital information before the newest information recording command is issued (Step 52). Thereafter, if the host has no command of adding a new session or changing the digital information state of these sessions issued temporarily, the present invention method proceeds to Step 54 to read these TOCs out from the memory directly. However, if a command for adding a new session and recording digital information to the newly-added session is issued, Step 57 combines the aforementioned TOCs and the TOC of this newly-added session together, thereby providing a refreshed TOC of the optical medium. The main reason of feasibility of combining TOCs stored in the memory previously and the TOC of the newly-added session together comes from the latter is known as this given session has just stored the digital information therein. In some cases, the command issued by the host is not to add another session but to change the digital information states, such as adding program areas to any given session having the digital information stored, changing the stored digital information, or erasing the content of any session, of sessions already have stored digital information therein, it is necessary to start out with the latest-stored session.

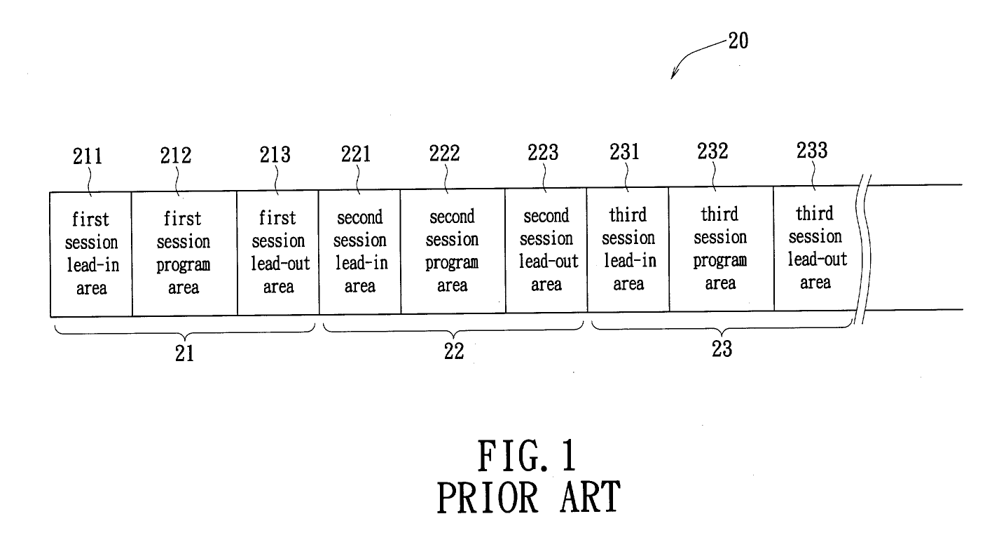

Please go back to FIG. 1 when it comes to the corresponding description illustrating the change of the digital information state that is selected from following four possibilities: 1) changing the size of the program area of the given session that has already stored the digital information; 2) changing the number of tracks of the program area of the session that has stored the digital information therein also; 3) erasing the content of the lead-in area of the session; and 4) erasing the content of any given session. Obviously, all of above four digital information state changes change the TOC accordingly. The digital information recording for current optical media is performed in accordance with the distribution of sessions thereon, which are arranged sequentially. That is, only after the information recording for the first session 21 is completed, another digital information can be recorded into the second session 22 and/or to the third session 23 in the wake of completion of information recording for the second session 22. Conversely, if the digital information state is going to be changed, it starts out with the latest-stored session (i.e., the third session 23, in this example). For these three sessions, the present method provides a memory to store the TOC of the lead-in area of the first session 211, as the respective digital information has been stored into the first session 21. Thereafter, if another digital information recording for the second session 22 is completed, the present method reads the TOC of the first session 21 out from the memory, and combines this TOC with the TOC of the second session 22. In the case of changing the digital information state of the first session 21, meaning not adding the second session 22, the refreshed TOC of the first session 21 will be restored into the memory again. The change of the first session 21 is selected from aforementioned four possibilities, which are correspondent to the change of the content of the program area thereof, the change of the size of the program area thereof, erasing of the content of the lead-in area of the first session 21, or erasing of all contents of all areas including the lead-in area, the lead-out area, and the program area of the first session 21. When it comes to changing the content of the program area, the content of the lead-in area should be changed, so as to unclose the session, in advance. After recording the digital information to the second session 22 and then intending to change the content of the first session 21, the present invention method erases contents of all areas of the second session 22, so as to change the content of the lead-in area 211 of the first session 21 and then to unclose the first session 21. Thereafter, the content of the program area of the first session 212 is ready to be changed. Since then, the TOC stored in the first session lead-in area 211 is changed also and the changed TOC is recorded into the memory again. For the second session 22, another information recording step is required for the purpose of storing the digital information thereto. Similarly, the TOC of the second session 22 will be stored into the memory as the information recording for the second session 22 is completed. In this way, as the information recording for the third session 23 is issued and completed, the present method reads TOCs of the first and second session stored in the memory out directly, and combines these TOCs with the current TOC of the third session 23 together, so as to have a refreshed TOC of the optical medium.

As for changing the digital information state of the first or second session, each of changing the size of the program area 212 or 222, changing the number of tracks of the program area 212 or 222, erasing the content of the first lead-in area 211 or second lead-in area 221, and erasing all contents of the first or second session is possible. If the content of the first session program area 212 or the first session lead-in area 211 will be changed after the information recording to the second session 22 is completed, all contents of the second session 22 will be erased in advance, thereby changing the content of the first session lead-in area 211 for unclosing the first session 21, which has stored the corresponding digital information therein ahead of the second session 22.

For avoiding any undesired consequence during the digital information recording, the method according to the present invention further includes a step of reading the TOC out from the third session lead-in area 231 and combining the third TOC with former two TOCs previously stored in the memory together, after the information recording to the third session 23 is completed. The same rule is applicable to the situation while the memory provided in the present invention has stored the first TOC from the first session therein and the digital information to the second session is completed. On this occasion, the optical pickup head moves to the second session lead-in area for reading the TOC thereof out, and the second TOC is combined with the first TOC has been stored in the memory provided previously, which is a little bit different from combining the first TOC from the memory with the second TOC, which is known over the period of information recording together.

The present invention further includes a step of changing the content of the program management area (PMA) of this given optical medium, while the digital information state thereof changes, and storing the content of PMA into the memory also. Therefore, the optical pickup head will no longer move to the PMA when it is necessary to retrieve the content of the PMA, as well as the case of reading TOCs of sessions. Besides, while the optical medium is under a test write operation, contents of the PMA, and all areas of sessions remain unchanged, therefore, if the memory has stored above contents therein previously, it is very convenient to read these information out directly without moving the pickup head to these areas anymore.

In comparison with prior arts, the present invention provides a memory for dynamically stores TOCs from sessions have already stored digital information therein, and, as the next information recording to next session is completed, no longer moves the pickup head to lead-in areas sequentially but combines these stored TOCs with the TOC of the session just stored the digital information therein, together, thereby providing a refreshed TOC of the optical medium. Additionally, the present method further provides a step of moving the pickup head to the lead-in area of the session just having stored the digital information therein, to read the TOC of this session out, and combining TOCs stored in the memory previously and the TOC directly from the lead-in area reading together, for the same purpose of moving the optical pickup head to every lead-in area, so as to save the time for the refreshed TOC providing.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for reading a table of content (TOC) of a multi-session optical medium, said multi-session optical medium including a plurality of sessions each including a lead-in area for storing said table of content thereof respectively, and a program area for storing a digital information, wherein said table of content is modified accordingly as a digital information state is changed, said method comprising:
providing a memory for storing said table of content of each said session having stored said digital information therein;
as the change of said digital information state is adding another said session, reading said tables of contents stored in said memory out; and combining said stored table of contents with said table of content of the newly-added said session together; and
as the change of said digital information state is not adding another said session, changing said digital information state of said latest-stored session at first, and at last storing the changed digital information state of said latest-stored session into said memory.

2. The method of claim 1, wherein changing said digital information state of said latest-stored session is for changing the size of said latest-stored session.

3. The method of claim 1, wherein changing said digital information state of said latest-stored session is for changing the number of tracks of said latest-stored session.

4. The method of claim 1, wherein changing said digital information state of said latest-stored session is for erasing the content of said lead-in area of said latest-stored session.

5. The method of claim 1, wherein changing said digital information state of said latest-stored session is for erasing the content of said latest-stored session.

6. The method of claim 5, wherein erasing the content of said latest-stored session is erasing contents of said lead-in area, said program area, and said lead-out area of said latest-stored session.

7. The method claim 5, wherein changing the content of said session located ahead of said latest-stored session is performed after the content of said latest-stored session is erased, and then said table of content of said session located ahead of said latest-stored session is refreshed.

8. The method of claim 1, further comprising refreshing the content of a program management area of said optical medium as said digital information state is changed, and then storing refreshed said program management area content into said memory.

9. The method of claim 8, wherein said stored program management area content and said table of contents of said sessions remain unchanged as the optical medium is under a test write operation.

10. A method for reading a table of content of an optical medium, said optical medium including a plurality of sessions each including a lead-in area for storing said table of content thereof respectively, and a program area for storing a digital information, wherein said digital information is stored into a first session, a first table of content of said first session is stored into said lead-in area of said first session, said method comprising:
providing a memory for storing said first table of content; reading said first table of content from said memory, and combining said first table of content with a second table of content, which is changed as said second session-is added, after said digital information is recorded to said newly-added second session;
refreshing said first table of content and then restoring said first table of content into said memory as no other said session is added and a digital information state of said first session is changed;
erasing said second session so as to change said digital information state of said first session, then refreshing said first table of content accordingly, and then restoring refreshed said first table of content to said memory, while said second session has been added; and
refreshing said second table of content, and then storing refreshed said second table of content into said memory, while said second session has been added and a digital information state of said second session is changed.

11. The method of claim 10, wherein changing said digital information state of said first or second session is for changing the size of said first or second sessions, respectively.

12. The method of claim 10, wherein changing said digital information state of said first or second session is for changing the number of tacks of said first or second session, respectively.

13. The method of claim 10, wherein changing said digital information state of said first or second session is for erasing said lead-in area of said first or second session, respectively.

14. The method of claim 10, wherein changing said digital information state of said first or second session is for erasing the content of said first or second session, respectively.

15. The method of claim 14, wherein erasing the content of said first or second session is for erasing contents of said lead-in area, said program area, and said lead-out area of said first or second session.

16. The method of claim 10, further comprising adding a third session, which is located after said first and second session, reading said first and second table of contents out from said memory, and then combining said first and second table of contents with a table of content of said third session together after said third session is added.

17. The method of claim 16, further comprising reading the content of said lead-in area of said third session out, and combining said lead-in area content of said third session with said first and second table of contents together, as said third session has been added.

18. The method of claim 16, further comprising changing the content of a program management area of said optical medium and storing the changed content of said program management area into said memory, as said digital information state of first or second or third session is changed.

19. The method of claim 10, further comprising changing the content of a program management area of said optical medium and storing the changed content of said program management area into said memory, as said digital information state of first or second session is changed.

20. The method of claim 19, wherein contents of said program management area, said first table of content, and said second table of content remain unchanged, as said optical medium is under a test write operation.

21. The method of claim 10, further comprising reading the content of said lead-in area of said second session, and combining said lead-in area content of said second session with said first table of content previously stored into said memory together.
